(19) United States
(12) Patent Application Publication
(10) Pub. No.: US 2010/0237219 A1
(43) Pub. Date: Sep. 23, 2010

(54) Multi-Purpose Fishing Rod Holder

(75) Inventor: Bruce Alexander Edwards, Queensland (AU)

Correspondence Address: SHOEMAKER AND MATTARE, LTD, 10 POST OFFICE ROAD - SUITE 100, SILVER SPRING, MD, 20910, US

(73) Assignee: RODLOK PTY LTD, Point Lookout, Queensland (AU)

(21) Appl. No.: 12/303,605

(22) PCT Filed: Jun. 6, 2007
(86) PCT No.: PCT/AU07/00792

§ 371 Date: Jan. 7, 2009

(30) Foreign Application Priority Data
Jun. 6, 2006 (AU) 2006903047

(51) Int. Cl. A01K 97/10

(52) U.S. Cl. 248/537; 248/534

(57) ABSTRACT

The present invention is directed to a two part rod holder which has a retaining member positionable about a fishing rod and a mounting member for providing support. The mounting member is interchangeable so that a different mounting member can be used for different situations such as mounting to a car or boat or placement in sand.

### FIELD OF INVENTION

The present invention relates to fishing rods and the transport and storage thereof. The present invention has particular but not exclusive application for mounting on cars and trucks. The main body of the specification describes the use of the invention on a car to transport fishing rods, but this is by way of example only and the invention is not limited to this use.

### BACKGROUND OF THE INVENTION

When carrying or transporting a fishing rod by car, it is usually positioned in a hollow cylindrical holder that is mounted to the bull-bar on the front of the vehicle. Usually there is a series of hollow cylindrical holders fixed to the bull-bar. The tip of the fishing rod extends rearwardly over the vehicle cabin and is often tied down by rope or chord to provide a second anchoring point and secure fastening.

The cylindrical holders are often made with an aluminum alloy and welded or clamped to the front bull-bar. These fixed cylindrical holders protrude outwardly and pose a danger to pedestrians and occupants in other cars should they be involved in an accident. Consequently these types of rod holders for vehicles are not encouraged by the road safety authorities.

However the only other alternative to transporting a fishing rod is to disassemble the rod to smaller lengths so that it can be stowed in the boot of a car. This alternative is sometimes not desirable or an option.

### OBJECT OF THE INVENTION

It is an object of the present invention to provide a rod holder that overcomes at least in part one or more of the above mentioned disadvantages and provide an alternative rod holder.

### SUMMARY OF THE INVENTION

In one aspect the present invention broadly resides in a two-part holder for a fishing rod including

a retaining member adapted to releaseably clamp to the fishing rod; and

a mounting member attachable to a surface or support wherein the retaining member is attachable to the mounting member.

The retaining member preferably has an attachment portion and a holding portion.

The holding portion preferably includes a cylindrical or tubular section in which the handle section or base of the fishing rod can be inserted. The holding portion preferably includes a clamping means for fixing the position of the inserted fishing rod. The clamping means preferably includes a quick release clamping arm for releasing and allowing removal of the fishing rod from the holding portion.

The attachment portion is preferably complementary to an engagement portion of the mounting member to enable releasable fitting of the retaining member to the mounting member. The portions may have complementary male and female parts. Preferably, one portion has a protrusion and the other portion has a jaw-like closure that can close about the protrusion.

Preferably the mounting member also includes a fixing portion which enables the mounting member to fix to the surface or support.

In one preferred embodiment, the mounting member has a base that is magnetized or has an adhesive layer to provide attachment to the surface or support. In an alternate preferred embodiment, the mounting member is fixed on or about a support by a bracket section.

The mounting member may take any suitable form that allows the rod holder to be used on cars, boats and dinghies or walls for storage purposes. The mounting member may alternatively be a spike portion for placement in sand or the like.

The mounting member in another embodiment is a mounting for use on a boat and has a fixing portion being a bracket for attaching to a tubular support such as a rail or the like and an engagement portion in which the retaining member is positionable. Preferably the engagement portion is rotatable relative to the fixing portion so that the inserted rod can be positioned pointing in any desired direction. Preferably the rotatable mounting portion can be locked in a desired position.

In another aspect the present invention broadly resides in a two-part holder for a fishing rod including

a retaining member adapted to releaseably clamp to the fishing rod, the retaining member has an attachment portion and a holding portion, the holding portion includes a cylindrical or tubular section for positioning the fishing rod, the holding portion includes a clamping means for fixing the positioned fishing rod, the clamping means includes a quick release clamping arm for releasing and allowing removal of the fishing rod from the holding portion, the attachment portion is complementary to an engagement portion of the mounting member to enable releasable fixing of the retaining member to the mounting member; and

a mounting member attachable to a surface or support wherein the retaining member is attachable to the mounting member, the mounting member includes a fixing portion which enables the mounting member to fix to the surface or support.

The retaining member is preferably made of plastics or other suitable material that enables the retaining member to float. When the floatable retaining member is fixed to a fishing rod, it allows the fishing rod to float in water enabling easy retrieval when accidentally dropped or lost in the sea or surf.

In a further aspect, the present invention broadly resides in a three-part rod holder for a fishing rod including

a retaining member adapted to releaseably clamp to the fishing rod;

a mounting member attachable to a surface or support wherein the retaining member is attachable to the mounting member; and

a holding member attachable to a surface or support and adapted to hold the tip or tip end of the fishing rod.

The features of the retaining member and mounting member as described above also apply with this aspect of the invention. The holding member preferably has a magnetic base and a clamping arm that secures about the tip or tip end of the fishing rod.

In another aspect, the present invention broadly resides in a rod holder system for transporting, carrying or using a fishing rod including

a retaining member adapted to clamp on or about the handle section or base of the fishing rod; and
one or more mounting members that is releaseably attachable to the retaining member, each of said one or more mounting members has a fixing portion wherein the fixing portion of each of said one or more mounting members is suitably shaped to fix to a particular surface or support and the retaining member can be releaseably attached to each of said one or more mounting members irrespective of the shape of the fixing portion.

In this way the rod holder system has a retaining member and a plurality of interchangeable mounting members each of which can be used in different circumstances. The rod holder system preferably enables the same rod collar clamped about a fishing rod to be releaseably attached to a number of different base mountings because they employ the same or universal engagement fitting. The rod holder system preferably has a plurality of interchangeable mounting members that have the same or universal engagement fitting.

The shape of the fixing portion preferably includes a bracket, a magnetized planar base, a spike or other suitable fixing portion.

The features of the retaining member and mounting member as described above also apply with this aspect of the invention.

### BRIEF DESCRIPTION OF THE DRAWINGS

In order that the present invention can be more readily understood and put into practical effect, reference will now be made to the accompanying drawings wherein:

FIG. 1 is a perspective view of the rod collar and base mounting of the preferred embodiment;

FIG. 2 is another perspective view of the rod collar and base mounting of the preferred embodiment;

FIG. 3 is another perspective view of the rod collar and base mounting of the preferred embodiment;

FIG. 4 is a perspective view of the rod collar and alternate base mounting;

FIG. 5 is another perspective view of the rod collar and base mounting of the preferred embodiment;

FIG. 6 is a side view of the rod collar and the alternate base mounting;

FIG. 7 is a bottom perspective view of the tip mounting;

FIG. 8 is top perspective view of the tip mounting;

FIG. 9 is another top perspective view of the tip mounting where a rod section is clamped in position;

FIG. 10 is another perspective view of the rod collar and base mounting of the preferred embodiment;

FIG. 11 is an exploded view of the parts of the rod holder of the preferred embodiment;

FIGS. 12, 13 and 14 are diagrammatic views of a rod holder for use on a boat; and

FIG. 15 is an exploded view of the parts of the rod holder mounting for a boat.

### DETAILED DESCRIPTION OF THE PREFERRED EMBODIMENT

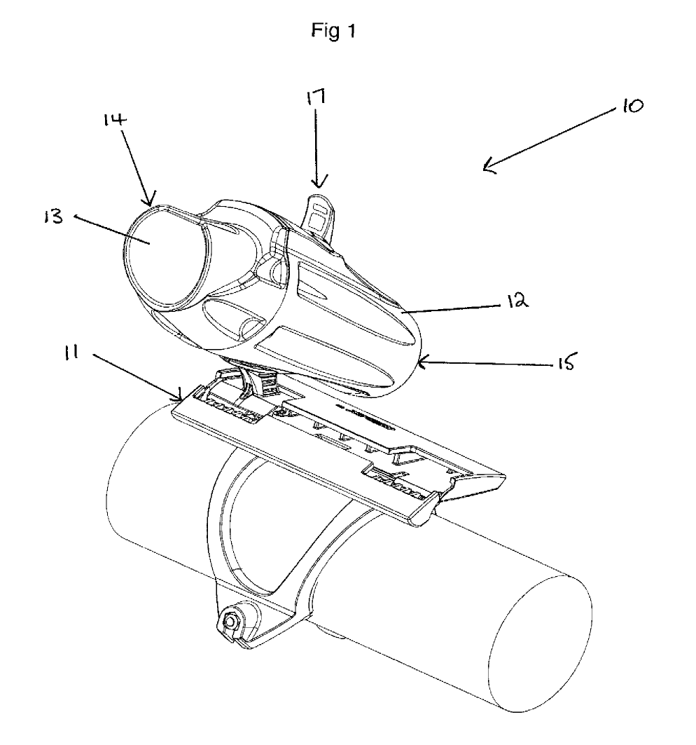

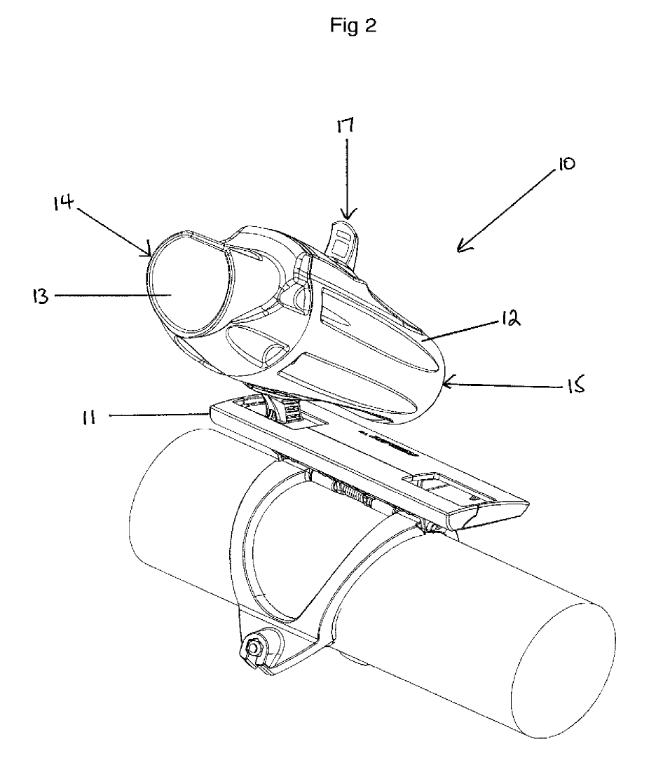

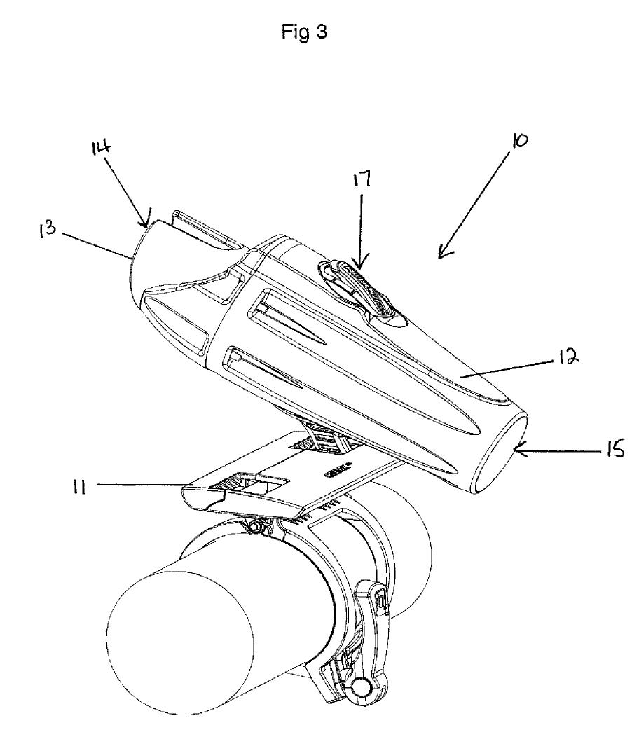

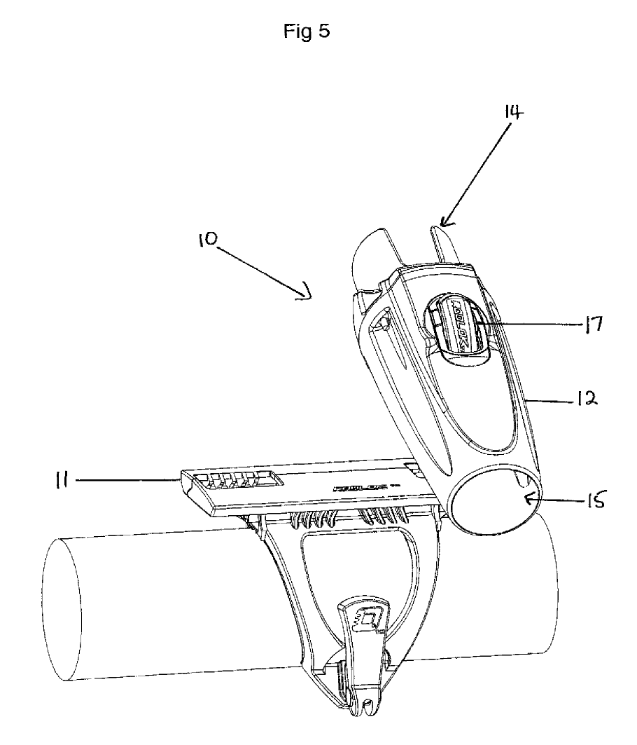

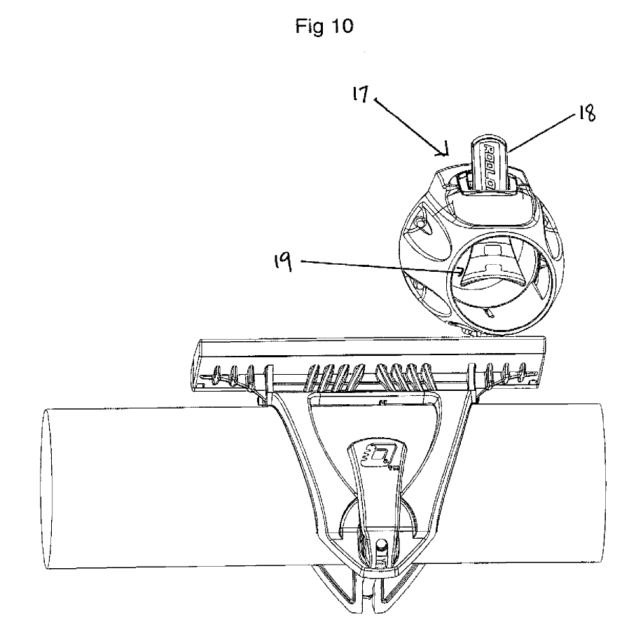

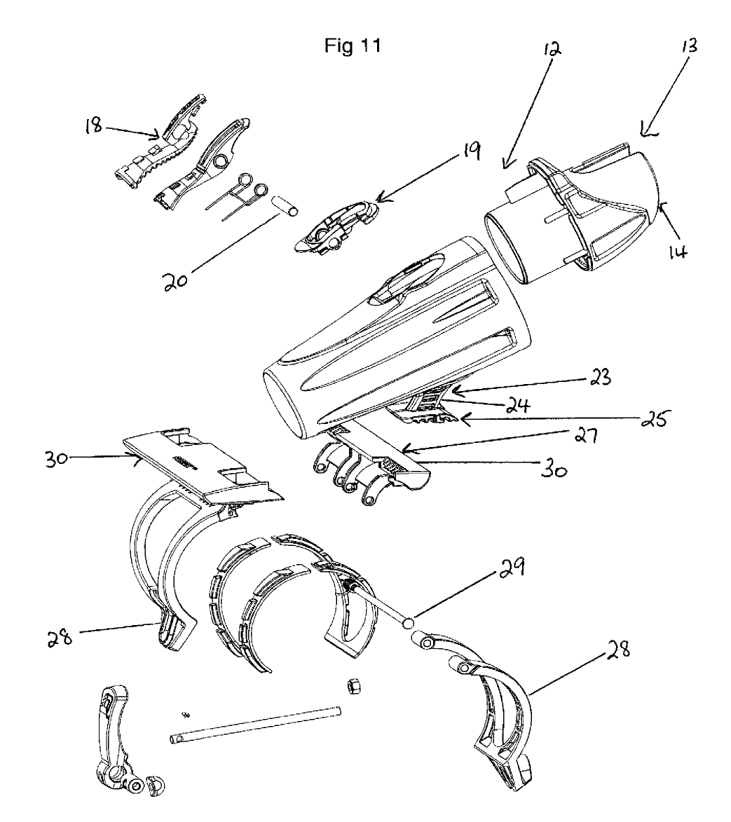

With reference to FIGS. 1, 2, 3, 5, 10 and 11 there is shown a rod collar 10 and base mounting 11. The rod collar 10 is a substantially cylindrical tube 12 with an opening 13 at the end 14 which has the comparatively widest diameter. The opposing end 15 is also open. The rod collar 10 also has a releasable clamp 17 which includes a quick release arm 18 and an engaging arm 19. The engaging arm 19 abuts the positioned rod handle or base (not shown) to clamp the rod collar 10 with the rod handle or base. The engaging arm 19 abuts the positioned rod handle or base when the quick release arm 18 actuates downward movement of the engaging arm 19 to clamp the rod. The quick release arm 18 and engaging arm 19 are both pivotally mounted about pivot pin 20 and spring biased to maintain the clamping position until the quick release arm 18 is released. The quick release arm 18 is released with upward movement of the arm 18 about the pivot pin 20. With upward movement of the quick release arm 18, the engaging arm 19 consequently moves upwards and disengages from the clamped position.

The rod collar 10 also has a mounting leg 23. The mounting leg 23 includes a leg portion 24 and a foot portion 25. The foot portion 25 is a slightly concave section substantially perpendicular to the leg portion 23. The foot portion 25 engages with the base mounting 11.

The base mounting 11 includes a jaws portion 27 and a bracket portion 28. The jaws portion 27 consists of two parts 30 joined by a spring biased pivot mounting 29 that urges closure of the two parts 30. The foot portion 25 of the rod collar 10 can be positioned within the jaws portion 27 and the two parts 30 are separated and retained in position when the two parts 30 are closed. The bracket portion 28 is fastenable about a suitable support such as a bull-bar on the front of a vehicle.

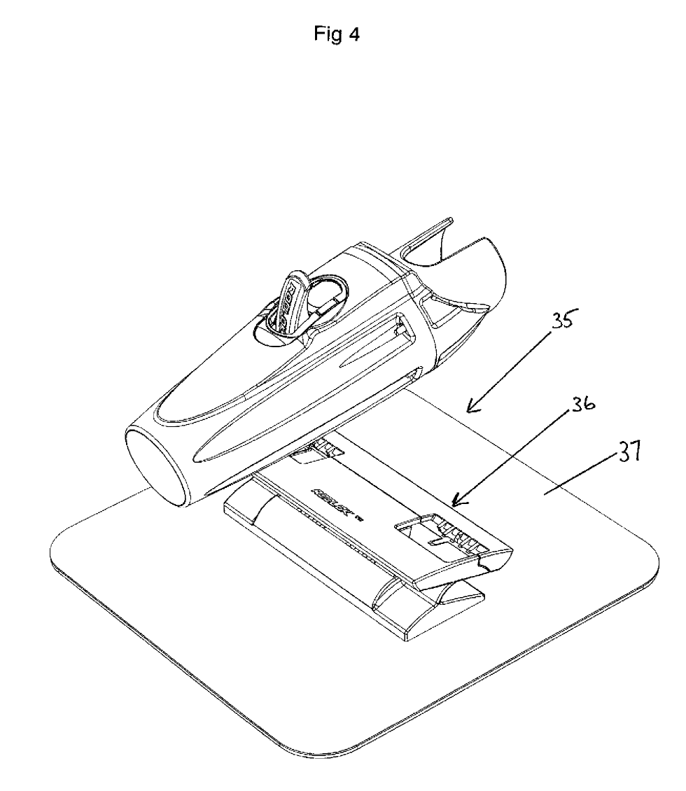

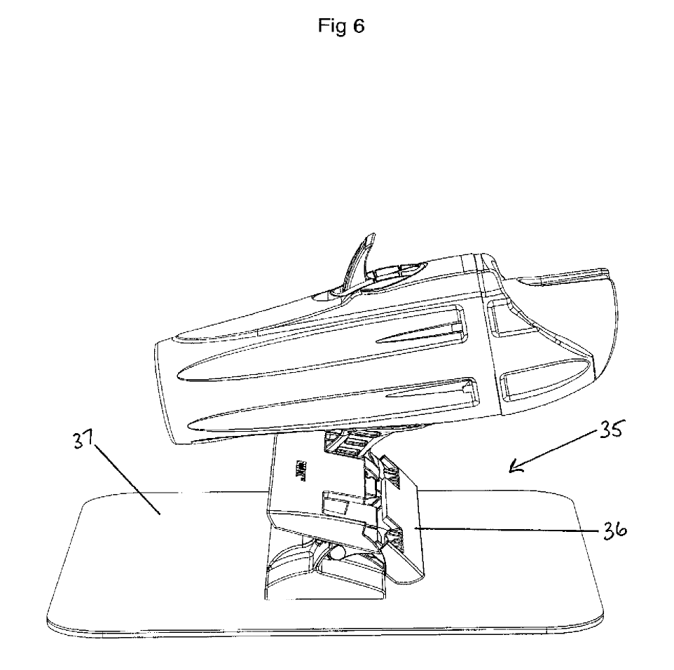

With reference to FIGS. 4 and 6, there is shown an alternate base mounting 35. The alternate base mounting 35 has a similar jaws potion 36 as described for the preferred embodiment. The alternate base mounting 35 has a magnetic portion 37 for attachment to a metal surface such as the bonnet or cabin roof of a vehicle. The alternate base mounting 35 with the magnetic portion 37 is suitable where there is no bull-bar or the like on which a bracket can be mounted.

There may be a number of different alternate base mountings depending on the application. For example, a further alternate base mounting may include a spike for placement in the sand or the like for use during surf fishing. A further example is a mounting to a sports or game fishing boat that enables a fishing line to be trawled while the fishing rod with the rod collar is held within a suitable mounting and not be dislodged when there is a strike on the fishing line.

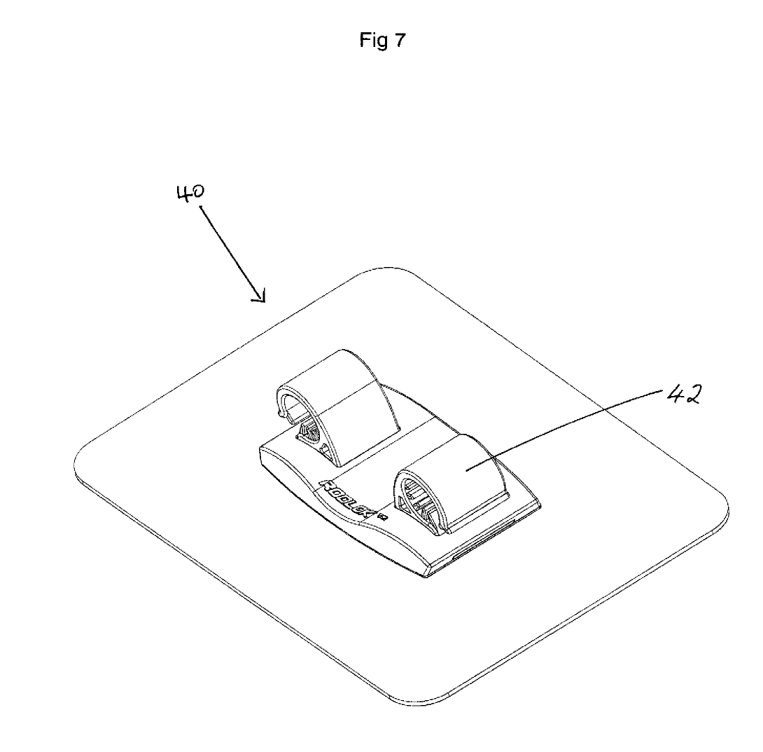

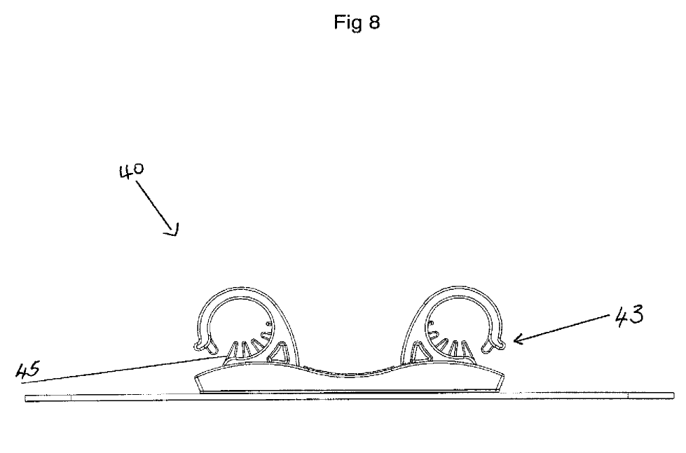

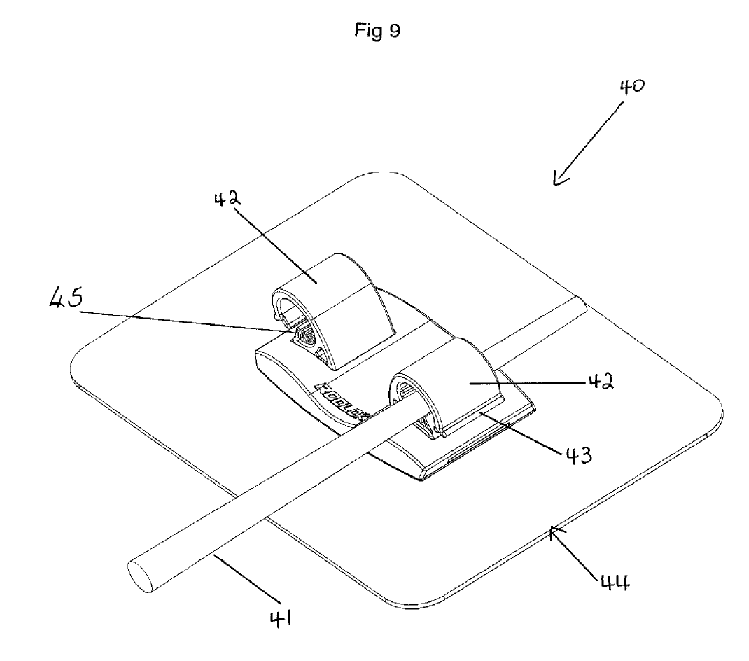

FIGS. 7, 8 and 9 show the tip mounting 40 where the tip of a rod 41 is maintained in position by a clamping arm 42. The clamping arm 42 is positioned to engage the clamping arm lip 43 with protruding teeth 45 to secure the clamping arm 42 about the rod 41. The tip mounting 40 has a magnetized base 44 which allows the tip mounting 40 to be located on any suitable metal surface such as the cabin roof of a vehicle.

In some situations, the rod collar and the base mounting may be used without the tip mounting.

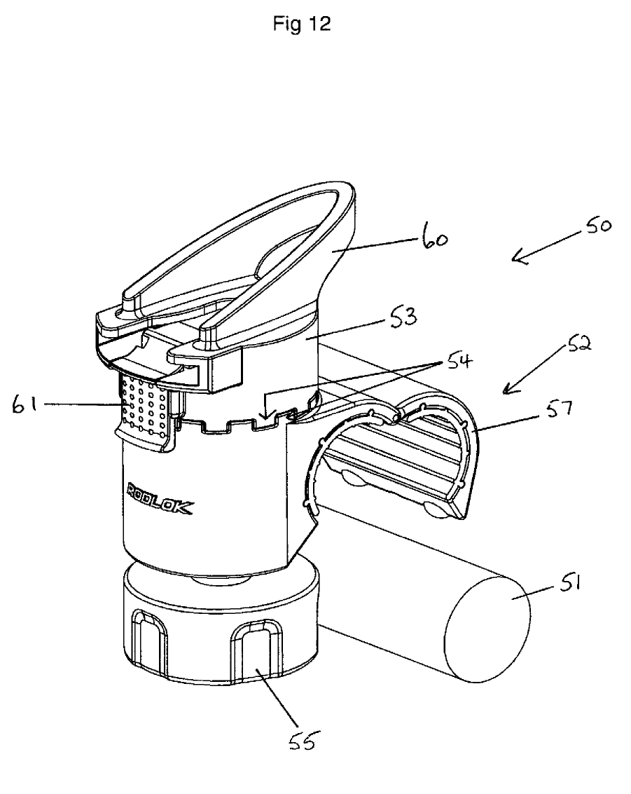

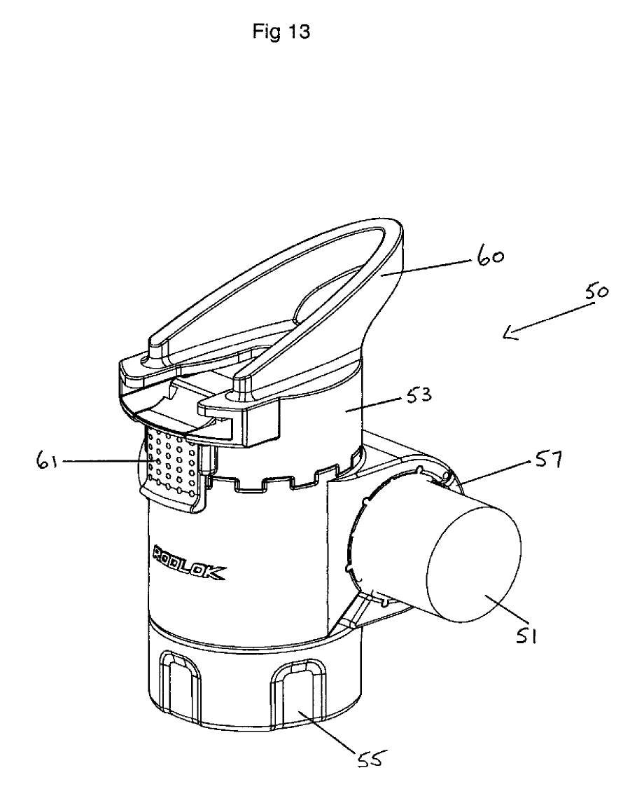

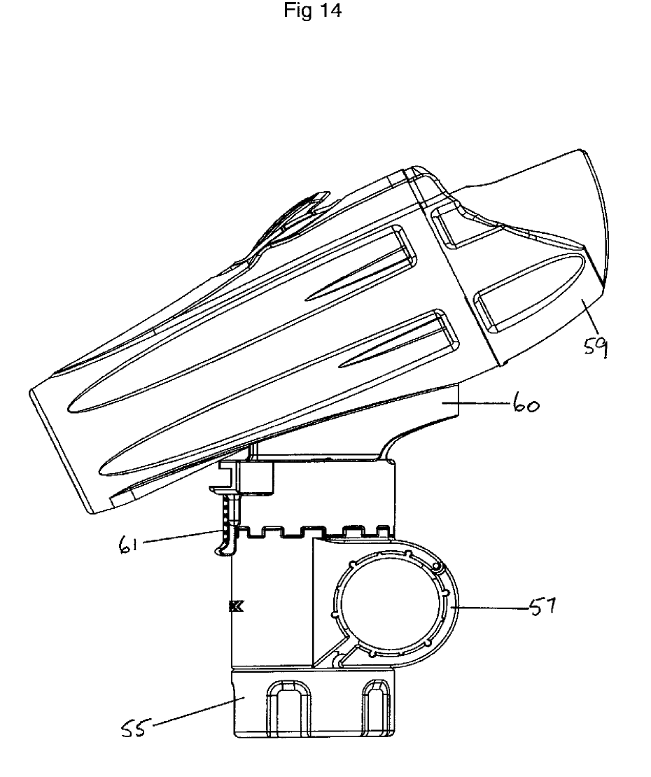

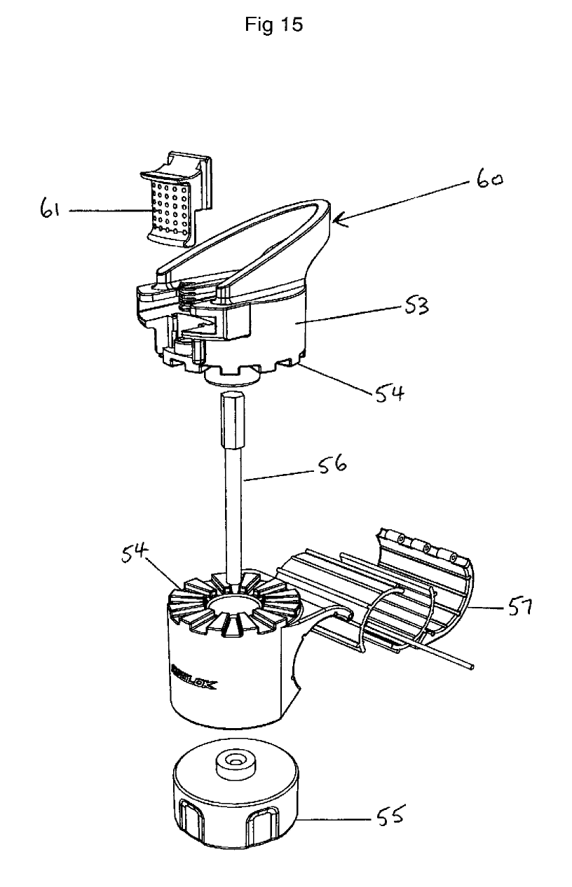

With reference to FIGS. 12, 13, 14 and 15, there is shown a rod holder mounting 50 for a boat. The rod holder mounting 50 is attachable to a tubular rail 51 by the clamping of bracket 52 with bracket arm 57 pivotally moving about rail 51. The engagement portion 53 is rotatable relative to the bracket 52. The engagement portion 53 can be locked into a desired position relative to the bracket 52 by the intercalating of complementary teeth 54. The movement of the engagement portion 53 relative to the bracket 52 is effected by the adjustment handle 55 which is operationally connected to the engagement portion 53 by a centrally positioned link rod 56. The retaining portion 59 is releaseably secured in the engagement portion 53 by sliding the retaining portion 59 in the complementary shaped top mounting 60 and securing in position by the spring biased catch 61.

### ADVANTAGES

The present invention provides the advantage that the rod holder can be quickly and easily removed when not in use and therefore do not pose a danger to pedestrians and occupants in other cars. The rod holder also has the advantage that it is part of a system where the same rod collar clamped about a fishing rod can be releaseably attached to a number of different base mountings as they employ the same or universal engagement fitting.

### Variations

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps.

1-12. (canceled)

13. A two-part holder for a fishing rod including
a retaining member having an attachment portion and a holding portion, the holding portion includes a cylindrical or tubular section positionable about the fishing rod, the holding portion includes a quick-release spring-biased clamping arm to clamp the positioned fishing rod, and
a mounting member having an engagement portion and a fixing portion, the engagement portion has spring-biased mounting to releaseably mount the attachment portion; wherein the fishing rod can be quickly released from the retaining member with a single movement of the clamping arm and the retaining member can be quickly released from the spring-biased mounting when desired.

14. A two-part holder for a fishing rod as claimed in claim 13 wherein the attachment portion is a protrusion with a substantially planar transverse mounting section, said substantially planar transverse mounting section is mountable to the spring-biased mounting.

15. A two-part holder for a fishing rod as claimed in claim 13 wherein the spring-biased mounting is a spring biased jaw-like closure able to clamp about the substantially planar transverse mounting section.

16. A two-part holder for a fishing rod as claimed in claim 13 wherein the spring-biased mounting includes a spring biased pin to hold the substantially planar transverse mounting section in position.

17. A two-part holder for a fishing rod as claimed in claim 13 wherein the mounting member has a base that is magnetized or has an adhesive layer to provide attachment to a surface or support.

18. A two-part holder for a fishing rod as claimed in claim 13 wherein the mounting member has a bracket for fixing to a support.

19. A two-part holder for a fishing rod as claimed in claim 13 wherein the mounting member has a spike portion for placement in sand or the like.

20. A two-part holder for a fishing rod as claimed in claim 13 wherein the mounting member has a bracket for clamping to a tubular support such as a rail or the like and a section rotatable relative to the fixing portion so that the inserted rod can be positioned in any desired direction.

21. A two-part holder for a fishing rod as claimed in claim 13 wherein there is a holding member attachable to a surface or support and adapted to hold the tip or tip end of the fishing rod.

22. A two-part holder for a fishing rod as claimed in claim 13 wherein the retaining member is floatable enabling the fishing rod fitted with the retaining member to float when in the water.

23. A rod holder system for transporting, carrying or using a fishing rod including
a retaining member having an attachment portion and a holding portion, the holding portion includes a cylindrical or tubular section positionable about the fishing rod, the holding portion includes a quick-release spring-biased clamping arm to clamp the positioned fishing rod, and
one or more mounting members that is releaseably attachable to the retaining member, each of said one or more mounting members having an engagement portion and a fixing portion, the engagement portion has spring-biased mounting to releaseably mount the attachment portion; wherein the fishing rod can be quickly released from the retaining member with a single movement of the clamping arm and the retaining member can be quickly released from the spring biased mounting when desired; wherein the fixing portion of each of said one or more mounting members is suitably shaped to fix to a particular surface or support and the retaining member can be releaseably attached to each of said one or more mounting members irrespective of the shape of the fixing portion.

24. A rod holder system as claimed in claim 23 wherein the one or more mounting members can mount the same attachment portion of the retaining member irrespective of the type of the spring-biased mounting.
